(19) United States
(12) Patent Application Publication
(10) Pub. No.: US 2008/0139710 A1
(43) Pub. Date: Jun. 12, 2008

(54) Conductive Composition, Conductive Molded Body and Conductive Gel Composition, and Method for Producing the Same

(75) Inventors: Yasuhiro Tsukada, Hyogo (JP); Hiroyuki Furutani, Osaka (JP); Mutsuaki Murakami, Osaka (JP); Tatsushi Yoshida, Hyogo (JP)

Correspondence Address: SUGHRUE MION, PLLC, 2100 PENNSYLVANIA AVENUE, N.W., SUITE 800, WASHINGTON, DC, 20037, US

(73) Assignee: KANEKA CORPORATION, Osaka-shi (JP)

(21) Appl. No.: 11/666,677

(22) PCT Filed: Oct. 27, 2005
(86) PCT No.: PCT/JP05/19772

§ 371 Date: May 1, 2007

(30) Foreign Application Priority Data
Nov. 1, 2004 (JP) 2004-318437
Nov. 30, 2004 (JP) 2004-346810
Mar. 15, 2005 (JP) 2005-073260

(51) Int. Cl. C08K 5/3492; C08L 61/22; C08K 5/3445; C08L 81/00

(52) U.S. Cl. 524/100; 524/597; 524/609; 524/543; 524/106

(57) ABSTRACT

A conductive composition containing a conductive polymer and an ionic liquid. At least part of the conductive polymer is dispersed and/or dissolved in the ionic liquid. In such a conductive composition, at least part of the conductive polymer can be dissolved in the ionic liquid. Thus, the film formability, moldability, and workability of a conductive polymer, which is generally insoluble and infusible, can be increased. More specifically, the invention can provide a conductive composition containing a conductive polymer and an ionic liquid and having high film formability, moldability, and workability.

### TECHNICAL FIELD

The present invention relates to a conductive composition containing an ionic liquid in which a conductive polymer, which is generally known to be insoluble and infusible, is dispersed and/or dissolved. The present invention also relates to a conductive molded body containing the conductive composition, to a conductive gel composition containing the conductive composition and a gelling agent, and to a method for producing them.

The present invention can extremely enhance the film formability, moldability and workability of conductive polymers and leads to a wide range of applications, such as for giving plastics conductivity and to electrochemical elements for solid capacitor electrolytes or secondary battery electrolytes, anticorrosion or anticontamination paints using a chemical reaction of the composition, display elements using doping/dedoping, actuators and other electromechanical conversion elements, electrooptic conversion elements including solar cells and polymer LEDs, and FETs and other semiconductor elements.

### BACKGROUND ART

The inception of conductive polymer is that it was found that high conductivity was produced by doping polyacetylene with iodine in 1977. Since the polyacetylene is insoluble and infusible, it was not used in practical applications. However if a conductive polymer that is soluble in a solvent or fusible is successfully developed, such a conductive polymer can be used in a wide range of applications, such as for giving plastics conductivity and to electrochemical elements for solid capacitor electrolytes or secondary battery electrolytes, anticorrosion or anticontamination paints using a chemical reaction of the composition, display elements using doping/dedoping, actuators and other electromechanical conversion elements, electrooptic conversion elements including solar cells and polymer LEDs, and FETs and other semiconductor elements. Accordingly, many attempts have been made to produce a solvent-soluble conductive polymer.

Among solvent-soluble polymers is poly(3-alkylthiophene) developed in 1986. Since this polymer is soluble in a solvent when it is dedoped, it must be doped for conductivity in another process. Polyaniline developed in 1992 is the first polymer that can be dissolved in a solvent in a doped state. The polyaniline is given a solvent-solubility by being doped with dodecylbenzenesulfonic acid.

In 1993, a method for producing a polyaniline soluble in water or an organic solvent was developed, as disclosed in Japanese Patent No. 3426637 (Patent Document 1). In this method, aniline is reacted with equimolar surfactant to form an aniline-surfactant salt as an aniline monomer having an amphiphilic structure, followed by oxidative polymerization. Thus, a polyaniline or its derivatives soluble in water or a variety of solvent, such as chloroform or xylene, or its derivatives can be synthesized.

As for water-dispersed conductive polymer, 1.3 mass % ethylenedioxythiophene dispersed in water was developed in 1993. Applications of such polythiophene have been disclosed in, for example, Japanese Unexamined Patent Application Publication No. 11-312626 (Patent Document 2). However, only the above-mentioned types of polymer have been known as solvent-soluble conductive polymers so far. For example, polyacetylene, polypyrrole, and polythiophene, which are typical conductive polymers, are considered to be insoluble and infusible. While conductive polymers have the possibility that they will be used in many fields, the range of their application has been limited.

In another field completely different from the field of electrochemical element technology, fused salts that are liquid at room temperature have been developed and have received attention. The liquid fused salts, which may be called ionic liquids, contain a quaternary salt, such as imidazolium or pyridinium, in combination of its cation and an appropriate anion (Br⁻, AlCl⁴⁻, BF₄⁻, PF₆⁻, etc.), and often contain halogen.

These liquid fused salts are nonvolatile, nonflammable, chemically stable, and ion-conductive, and have received attention as recyclable green solvent used in chemical reactions, such as synthesis or catalytic reaction. In addition, they have been studied for the electrolyte of Li ion cells and the possibility as a double-layer capacitor. The use of ionic liquids as double-layer capacitors is based on their relatively large potential window, and is intended to increase the double-layer capacitance.

However, liquid electrolyte may undesirably leak from, for example, a cell. Accordingly, it has been proposed that ionic liquid is gelated to prepare a solid electrolyte containing the ionic liquid (see, for example, Japanese Unexamined Patent Application Publication No. 2002-003478 (Patent Document 3)). Conductive gel materials are expected to be used not only as solid electrolyte, but also for biological electrodes, sensors, and the like.

Even in an ionic liquid (ion conductor) prepared by directly gelating an ionic liquid, however, the specific conductance (electrical conductivity) is reduced by gelation. In order to expand the application as a solid electrolyte or a biological electrode or sensor, it is desired that the conductivity of the ionic liquid be further increased.

Patent Document 1: Japanese Patent No. 3426637

Patent Document 2: Japanese Unexamined Patent Application Publication No. 11-312626

Patent Document 3: Japanese Unexamined Patent Application Publication No. 2002-003478

### DISCLOSURE OF THE INVENTION

### Problems to be Solved by the Invention

The object of the present invention is to increase the film formability, moldability, and workability of conductive polymer, which is generally known to be insoluble and infusible. More specifically, the object of the invention is to provide a conductive composition containing a conductive polymer and an ionic liquid and exhibiting high film formability, moldability, and workability.

### Means for Solving the Problems

In the present invention, a conductive composition is provided which contains a conductive polymer and an ionic liquid. At least part of the conductive polymer is dispersed and/or dissolved in the ionic liquid.

In the conductive composition of the present invention, at least of the conductive polymer may be dissolved in the ionic liquid. Also, the concentration of the conductive polymer in the ionic liquid may be at least 0.6 times as high as the saturated concentration of the conductive polymer in the ionic liquid.

In the conductive composition of the present invention, the conductive polymer may contain at least one selected from the group consisting of polypyrrole and its derivatives, polythiophene and its derivatives, poly(para-phenylene vinylen) and its derivatives, polyaniline and its derivatives, and polyquinone and its derivatives.

In the conductive composition of the present invention, the ionic liquid may contain at least one cationic component selected from the group consisting of ammonium and its derivatives, imidazolinium and its derivatives, pyridinium and its derivatives, pyrrolidiniumand its derivatives, pyrrolinium and its derivatives, pyrazinium and its derivatives, pyrimidinium and its derivatives, triazonium and its derivatives, triazinium and its derivatives, triazine derivative cations, quinolinium and its derivatives, isoquinolinium and its derivatives, indolinium and its derivatives, quinoxalinium and its derivatives, piperazinium and its derivatives, oxazolinium and its derivatives, thiazolinium and its derivatives, morpholinium and its derivatives, and piperazine and its derivatives.

In the conductive composition of the present invention, the ionic liquid may contain at least one anionic component selected from the group consisting of sulfonate anion (—SO₃⁻), sulfate anion (—SO₄⁻), carboxylate anion (—COO⁻), BF₄⁻, PF₆⁻, bis(trifluoromethylsulfonyl)imide anion ((CF₃SO₂)₃C³¹ ), NO₃⁻, and nitro anion (—NO₂⁻).

The conductive composition of the present invention may be prepared through the step of dispersing and/or dissolving the conductive polymer in the ionic liquid.

The conductive composition of the present invention may be a conductive composition prepared by removing at least part of the ionic liquid from the above conductive composition. For example, the conductive composition of the present invention may be a conductive composition prepared by bringing the above conductive composition into contact with a liquid compatible with the ionic liquid to remove at least part of the ionic liquid.

In the present invention, a conductive molded body is provided which contains any one of the above conductive compositions. For example, the conductive molded body of the present invention may be produced using at least one of the above conductive compositions.

In the present invention, a conductive gel composition is provided which contains the conductive composition and a gelling agent.

In the conductive gel composition of the present invention, the concentration of the conductive polymer in the ionic liquid may be at least 0.2 times as high as the saturated concentration of the conductive polymer in the ionic liquid. Also, the concentration of the gelling agent in the ionic liquid may be in the range of 0.03 to 0.5 g/mL.

In the conductive gel composition of the present invention, the gelling agent may contain at least two polar groups or at least two reactive functional groups.

In the present invention, a method for producing the conductive gel composition is provided. The method includes the dissolving step of dissolving at least part of the conductive polymer in the ionic liquid; and the gelating step of gelating the ionic liquid in which at least part of the conductive polymer is dissolved with the gelling agent.

In the method for producing the conductive gel composition, the gelating step may include the step of dissolving or dispersing the gelling agent in the ionic liquid in which at least part of the conductive polymer is dissolved. Also, the gelating step includes the steps of: preparing the gelling agent including a first gelling agent having at least two first reactive functional groups and a second gelling agent having at least two second reactive functional groups; dissolving or dispersing the first gelling agent and the second gelling agent in the ionic liquid in which at least part of the conductive polymer is dissolved; and polymerizing the first gelling agent and the second gelling agent.

### EFFECTS OF THE INVENTION

According to the present invention, the film formability, moldability, and workability of a conductive polymer, which is generally insoluble and infusible, can be increased. More specifically, the present invention can provide a conductive composition containing a conductive polymer and an ionic liquid and having high film formability, moldability, and workability.

### BEST MODES FOR CARRYING OUT THE INVENTION

<Conductive Composition>

A conductive composition according to the present invention contains a conductive polymer and an ionic liquid, and at least part of the conductive polymer is dispersed and/or dissolved in the ionic liquid. In such a conductive composition, the film formability, moldability, and workability of the conductive polymer can be enhanced.

(Ionic Liquid)

The ionic liquid used herein, which may be called ambient temperature molten salt, contains a cation and an anion and is liquid at least at room temperature (for example, 10 to 30° C.). Some ionic liquids are liquid even at 100° C. or more, or 150° C. or more. Unlike ordinary organic solvents part of which is ionized, the ionic liquid is composed of only ions (cation and anion); hence, the ionic liquid is considered to be 100% ionized.

The cation component constituting the ionic liquid is preferably, but not limited to, a cation containing a quaternary nitrogen from the viewpoint of increasing the chemical stability and conductivity of the ionic liquid. For example, the cation is preferably at least one selected from the group consisting of ammonium and its derivatives, imidazolinium and its derivative, pyridinium and its derivatives, pyrrolidinium and its derivatives, pyrrolinium and its derivatives, pyrazinium and its derivatives, pyrimidinium and its derivatives, triazonium and its derivatives, triazinium and its derivatives, triazine derivative cation, quinolinium and its derivatives, isoquinolinium and its derivatives, indolinium and its derivatives, quinoxalinium and its derivatives, piperazinium and its derivative, oxazolinium and its derivatives, thiazolinium and its derivatives, morpholinium and its derivatives, and piperazine and its derivatives. The derivative used herein refers to a substituted compound prepared by replacing at least one substituent hydrogen atom of its fundamental compound with a substituent, such as aliphatic hydrocarbon, alicyclic hydrocarbon, aromatic hydrocarbon, hydroxy, carbonyl, carboxyl, ether, ester, acyl, or amino.

The anion component constituting the ionic liquid is preferably, but not limited to, at least one selected from the group consisting of sulfonate anion (—SO₃⁻), sulfate group-containing anion (—OSO₃⁻), carboxylate anion (—COO⁻), BF₄⁻, PF₆⁻, bis(trifluoromethylsulfonyl)imide anion ((CF₃SO₂)₂N⁻), tris(trifluoromethylsulfonyl) carboanion ((CF₃SO₂)₃C⁻), NO₃⁻, and nitro anion (—NO₂³¹ ) from the viewpoint of increasing the conductivity of the ionic liquid.

Preferred anion components used in the present invention can be atomic groups containing a sulfonate anion (—SO₃⁻) or a sulfate anion (—OSO₃⁻). These anion components are expressed by R_{A}SO₃⁻ and R_{B}OSO₃⁻ (wherein R_{A} and R_{B} each represent a substituent containing an aliphatic hydrocarbon group, an alicyclic hydrocarbon group, an aromatic hydrocarbon group, an ether group, an ester group, an acyl group, or any other group, or may contain fluorine atom).

R_{A}SO₃⁻ may be, for example, p-CH₃C₆H₄SO₃⁻(p-toluenesulfonate anion) or C₆H₅SO₃⁻(benzenesulfonate anion). More preferably R_{A} of R_{A}SO₃⁻ contains fluorine atom. Such R_{A}SO₃⁻ may be, for example, CF₃SO₃⁻, CHF₂CF₂CH₂SO₃⁻, or CHF₂—(CF₂)₃—CH₂SO₃⁻.

R_{B}OSO₃⁻ may be, for example, CH₃CH₂OCH₂CH₂OSO₃⁻ or C₆H₅OCH₂CH₂OSO₃⁻. More preferably R_{B} of R_{B}OSO₃⁻ contains fluorine atom. Such R_{B}OSO₃⁻ may be, for example, CHF₂CF₂CH₂OSO₃⁻, CHF₂—(CF₂)₃—CH₂OSO₃⁻, CF₃—(CF₂)₂—CH₂OSO₃⁻, or CF₃—(CF₂)₆—CH₂OSO₃⁻.

Preferred anion components used in the present invention can also be atomic groups containing a carboxylate anion (—COO⁻), such as R_{C}COO⁻, HOOCR_{C}COO⁻, ⁻OOCR_{C}COO⁻, or NH₂CHR_{C}COO⁻ (wherein R_{C} represents a substituent containing an aliphatic hydrocarbon group, an alicyclic hydrocarbon group, an aromatic hydrocarbon group, an ether group, an ester group, an acyl group, or any other group, or may contain fluorine atom). Specifically, the ionic liquid preferably contains a carboxylate anion (—COO⁻) synthesized using formic acid, acetic acid, maleic acid, adipic acid, oxalic acid, phthalic acid, succinic acid, amino acid, or the like.

Preferred anion components used in the present invention can also be atomic groups containing a nitro anion (—NO₂—), such as R_{D}NO₂⁻ (wherein R_{D} represents a substituent containing an aliphatic hydrocarbon group, an alicyclic hydrocarbon group, an aromatic hydrocarbon group, an ether group, an ester group, or an acyl group, or may contain fluorine atom).

Furthermore, preferred anion components used in the present invention include BF₄⁻, PF₆⁻, bis(trifluoromethylsulfonyl)imide anion ((CF₃SO₂)₂N⁻), and (tris(trifluoromethylsulfonyl)carboanion ((CF₃SO₂)₃C³¹ ).

The ionic liquid used in the present invention is a chemical substance prepared by combining a cation component and an anion component, and can be synthesized by a known method, such as anion exchange, acid ester method, or neutralization.

(Conductive Polymer)

The conductive polymer used in the present invention is preferably, but not limited to as long as being conductive, at least one selected from the group consisting of polypyrrole and its derivatives, polythiophene and its derivatives, poly(para-phenylene vinylen) and its derivatives, polyaniline and its derivatives, and polyquinone and its derivatives in view of their high conductivities. The derivative used herein refers to a substituted compound prepared by replacing at least one substituent hydrogen atom of its fundamental compound with a substituent, such as aliphatic hydrocarbon, alicyclic hydrocarbon, aromatic hydrocarbon, hydroxy group, carbonyl, carboxyl, ether, ester, acyl, or amino. Exemplary derivatives include poly(1,4-dioxythiophene), poly(3-alkylthiophene) (the alkyl group may be butyl, hexyl, octyl, dodecyl, etc.), and poly(1,5-diaminoanthraquinone).

The conductive polymer is synthesized by chemical polymerization, electrolytic polymerization, or the like. The chemical polymerization is a method in which a raw material monomer, such as pyrrole, is polymerized by oxidative dehydration in the presence of an appropriate oxidizing agent. The oxidizing agent can be a persulfate, hydrogen peroxide, or a salt of transition metal, such as iron, copper, or manganese. The anion component of the oxidizing agent is taken into the polymer as dopant during polymerization, and thus a conductive polymer is produced in a single step reaction. The electrolytic polymerization is a method in which a raw material monomer, such as pyrrole, is dissolved in a solvent with an electrolyte and is subjected to oxidative polymerization on an anode. Since the oxidation-reduction potential of a polymer is generally lower than that of the monomer, the oxidative polymerization of the polymer skeleton progresses, and thus the electrolyte in the solvent is taken in the polymer to act as dopant in the process of the polymerization.

Exemplary dopants added to the conductive polymer include, but not limited to, p-toluenesulfonate anion, benzenesulfonate anion, anthraquinone-2-sulfonate anion, triisopropylnaphthalenesulfonate anion, polyvinylsulfonate anion, dodecylbenzenesulfonate anion, alkylsulfonate anion, n-propylphosphate anion, ClO₄⁻BF₄⁻, and PF₆⁻.

The expression “at least part of the conductive polymer is dispersed and/or dissolved in the ionic liquid” means that: (A) at least part of the conductive polymer may be dispersed in the ionic liquid; (B) part of the conductive polymer may be dissolved in the ionic liquid and another part or the other part is dissolved in the ionic liquid; or (C) at least part of the conductive polymer may be dissolved in the ionic liquid. In addition to (A) to (C), (D) part of the conductive polymer may not be dispersed or dissolved in the ionic liquid. In any case of (A) to (C), the film formability, moldability, and workability of the conductive polymer can be enhanced.

The conductive polymer can be dispersed and/or dissolved in the ionic liquid by any common method without particular limitation. For example, for dispersing and/or dissolving polypyrrole, which is a type of conductive polymer, it is preferable that polypyrrole is dispersed and/or dissolved in an ionic liquid heated to 50° C. or more, from the viewpoint of increasing the solubility of polypyrrole. In such a dispersing and/or dissolving step, the ionic liquid is preferably heated to 100° C. or more, and more preferably to 150° C. or more, as long as the temperature is not more than the boiling point. As the temperature of the ionic liquid is increased, the solubility of the conductive polymer increases, and the conductive polymer dissolved in the high-temperature ionic liquid does not separate out even if it is cooled to room temperature. This suggests that the dissolution of the conductive polymer in the ionic liquid differs from ordinary dissolution in a solvent, and is based on a strong interaction like a doping action in the conductive polymer.

The same applies to the dispersion and/or dissolution of other conductive polymers in an ionic liquid. For example, in the step of dispersing and/or dissolving polythiophene in an ionic liquid, polythiophene is preferably dispersed and/or dissolved in the ionic liquid heated to 50° C. or more, more preferably heated to 100° C. or more, and still preferably heated to 150° C. or more.

In the conductive composition of the present invention, preferably, at least part of a conductive polymer is dissolved in an ionic liquid. By dissolving at least part of the conductive polymer in the ionic liquid, the film formability, moldability, and workability of the conductive polymer can be enhanced.

Whether or not the polymer is dissolved in the ionic liquid is checked by the following three methods of observing: (1) whether a residue is left by filtration through a filter; (2) whether or not the polymer is separated out by centrifugation; and (3) whether the absorption intensity of the conductive polymer in an ultraviolet-visible absorption spectrum is proportional to the amount of the conductive polymer added. The method (3) with an ultraviolet-visible absorption spectrum is according to molecular absorption and is based on the principle that even if a conductive polymer reaches a point of saturation and is present in a state of such fine particles that cannot be separated out by filtration or centrifugation, the absorption intensity of the conductive polymer in such a state is lower than that of the polymer dissolved in a state of molecule.

In the conductive composition of the present invention, the concentration of the conductive polymer in the ionic liquid is preferably at least 0.6 times as high as the saturated concentration of the conductive polymer in the ionic liquid, from the viewpoint of increasing the conductive polymer concentration in the conductive composition while the film formability, moldability, and workability of the conductive polymer is kept high. If, for example, the conductive composition is used for coating, the higher the concentration of the conductive polymer, the better because the amount of the conductive polymer applied at a time is increased. The concentration of the conductive polymer is more preferably at least 0.7 times as high as the saturated concentration, and still preferably at least 0.8 times as high as the saturated concentration.

The saturated concentration of the conductive polymer in the ionic liquid is calculated, for example, as below. In a well-dried 100 mL (cm³) two-neck flask equipped with a stirring paddle and a Liebig reflux condenser, Y g of conductive polymer is added to X mL of ionic liquid and the mixture is heated with stirring at 150° C. for 30 minutes to dissolve or disperse the conductive polymer in the ionic liquid. The resulting solution or suspension is cooled to room temperature (for example, 10 to 30° C.) and subsequently filtered through a filter (No. 2, produced by Toyo Roshi). As a result, a portion of the conductive polymer not dissolved in the ionic liquid is left on the filter. The undispersed or undissolved portion of the conductive polymer is washed with water and methanol, and then dried. When the weight of the dried conductive polymer is Z g, the saturated concentration M_{S} is calculated from Equation (1):

M_{S}(g/mL)=(Y−Z)/X (1)

Since the amount of dissolved conductive polymer in the ionic liquid depends on the types of ionic liquid and conductive polymer, it is necessary to adjust the X and Y values so as to be Z>0.

Since the absorption intensity of the ultraviolet-visible absorption spectrum of the conductive polymer is proportional to the amount of the conductive polymer dissolved in the ionic liquid, the concentration of the conductive polymer in the ionic liquid at which the absorption intensity is maximum can be defined as the saturated concentration. For example, Y₁, Y₂ and Y₃ to Yₙ g of conductive polymer are dispersed or dissolved separately in X mL of ionic liquid to prepare conductive composition samples. Each conductive composition sample is measured for an ultraviolet-visible absorption spectrum. The measurement wavelength is preferably set at the maximum absorption wavelength of the solution. The relationship between the concentration and the absorption intensity of the ultraviolet-visible absorption spectrum is plotted. The conductive polymer is considered to be dissolved until it has a concentration at which the absorption intensity is saturated.

Preferably, the concentration M of the conductive polymer in the ionic liquid and the saturated concentration M_{S} of the conductive polymer in the ionic liquid have the relationship (M/M_{S})≧0.6.

According to the homepage (the following URL) of the manufacturer (http://www.advantec.co.jp/japanese/hinran/seihin-index.html), the above filter has a catalog-specified particle retention size of 5 μm (derived from the size of particles that can pass through the filter when barium sulfate or the like is normally filtered according to JIS P 3801).

In the conductive composition of the present invention, it is also preferable that at least part of the ionic liquid be removed from the conductive composition in which the conductive polymer is dispersed and/or dissolved in the ionic liquid, from the viewpoint of the production of a conductive molded body containing the conductive polymer. In order to remove at least part of the ionic liquid from the conductive composition, the conductive composition is preferably, but not limited, brought into contact with a liquid compatible with the ionic liquid. In order to bring the conductive composition into contact with the ionic liquid, the conductive composition is preferably, but not limited, immersed or shaken in the ionic liquid. Preferred ionic liquid-compatible liquids include, but not limited to, water, acetone, hexane, and dichloroethane.

The conductive composition of the present invention, that is, the conductive composition containing an ionic liquid and a conductive polymer part of which is dispersed and/or dissolved in the ionic liquid, can be applied to a wide range of areas, such as of conductive ink and for giving conductivity to polymer. One of the features of the conductive composition of the present invention is that the ionic liquid is nonvolatile and has substantially no boiling point. It is therefore difficult to form a conductive polymer film by coating the conductive composition on a substrate and drying the solvent, if the conductive composition is used as it is. However, a paper-like or cloth-like conductive sheet can be easily produced by impregnating the conductive composition of the present invention into a medium or the like made of a natural polymer (for example, cloth made of at least one natural organic polymer selected from the group consisting of paper, cotton, hemp, silk, and the like) or an organic compound (graphite sheet, polymer film), and then washing the medium with a liquid compatible with the ionic liquid to extract only the ionic liquid. This technique can be applied to any other polymer in the same manner, and thus a coating film made of the conductive polymer and a polymer can be easily produced.

While the conductive composition of the present invention contains a conductive polymer dispersed and/or dissolved in an ionic liquid, a conductive composition containing a conductive polymer dispersed and/or dissolved in a fluorinated alcohol also produces the same effect as the invention.

More specifically, the conductive composition containing a conductive polymer and a fluorinated alcohol in which at least part of the conductive polymer is dispersed and/or dissolved can enhance the firm formability, moldability, and workability of the conductive polymer, as well as the conductive composition of the present invention.

In order to enhance the film formability, moldability, and workability of conductive polymer, it is preferable that in the conductive composition containing a conductive polymer and a fluorinated alcohol, at leas part of the conductive polymer be dissolved in the fluorinated alcohol. Also, the concentration of the conductive polymer in the fluorinated alcohol is preferably at least 0.6 times as high as the saturated concentration of the conductive polymer in the fluorinated alcohol.

A conductive composition containing a conductive polymer dispersed and/or dissolved in a fluorinated alcohol and a chlorinated hydrocarbon can also produce the same effect as the present invention.

More specifically, the conductive composition containing a conductive polymer, a fluorinated alcohol, and a chlorinated hydrocarbon in which part of the conductive polymer is dispersed and/or dissolved in a mixed solvent of the fluorinated alcohol and the chlorinated hydrocarbon can enhance the film formability, moldability, and workability of the conductive polymer, as well as the conductive composition of the invention.

In order to enhance the film formability, moldability, and workability of conductive polymer, it is preferable that in the conductive composition containing a conductive polymer, a fluorinated alcohol, and a chlorinated hydrocarbon, at least part of the conductive polymer be dissolved in a mixed solvent of the fluorinated alcohol and the chlorinate hydrocarbon. Also, the concentration of the conductive polymer in the mixed solvent of the fluorinated alcohol and the chlorinate hydrocarbon is preferably at least 0.6 times as high as the saturated concentration of the conductive polymer in the mixed solvent.

The fluorinated alcohol used in the above conductive composition may be, but not limited to, a monohydric alcohol or a polyhydric alcohol. When a fluorinated monohydric alcohol is expressed by the chemical formula R_{E}—OH, it is preferable, but not limited to, that R_{E} be an alkane, an alkene or a monocyclic hydrocarbon having a carbon number of 2 to 6, and that the number of fluorine atoms be larger than the number of hydrogen atoms, from the viewpoint of enhancing the solubility of the conductive polymer. More specifically, for example, when R_{E} is an alkane and it is, for example, the ethyl group, R_{E} preferably have fluorine atoms more than or equal to those of —C₂H₂F₃, that is, R_{E} is preferably —C₂H₂F₃, —C₂H₁F₄, or —C₂F₅. Also, when R_{E} is the propyl group, R_{E} preferably has fluorine atoms more than or equal to those of —C₃H₃F₄, that is, R_{E} is preferably —C₃H₃F₄, —C₃H₂F₅, —C₃H₁F₆, or —C₃F₇. For example, a particularly preferred fluorinated alcohol may be, but not limited to, hexafluoroisopropanol.

The fluorinated alcohol may be mixed with another solvent and used as a mixed solvent. The fluorinated alcohol and another solvent are not particularly limits as long as they can disperse and/or dissolve the conductive polymer.

The solvent mixed with the fluorinated alcohol is particularly preferably a chlorinated hydrocarbon solvent. Such chlorinated hydrocarbon solvents include chloroform, dichloromethane, and carbon tetrachloride. Among these particularly preferred is, but not limited to, chloroform. Such a chlorinated hydrocarbon solvent is mixed with the fluorinated alcohol to be used. For example, chloroform may be mixed with hexafluoroisopropanol to prepare a mixed solvent. The hexafluoroisopropanol/chloroform ratio in the mixed solvent is preferably, but not limited to, 4 parts by mass to 1 part by mass. The mixed solvent with this ratio can lead to the most preferred solubility. For example, the fluorinated alcohol ratio is preferably in the range of 0.5 to 100 parts by mass to 1 part by mass of the chlorinated hydrocarbon, more preferably in the range of 1 to 50 parts by mass to 1 part by mass of chlorinated hydrocarbon, and still more preferably in the range of 2 to 6 part by mass to 1 part by mass of chlorinated hydrocarbon.

<Conductive Molded Body>

A molded body according to the present invention contains the conductive composition described above. The molded body used herein is formed by molding a material containing the conductive composition into a paper-like or cloth-like sheet, a film, a pellet, foam, a block, or any other form without particular limitation. Extrusion, blowing, vacuum forming, injection molding, die extrusion, or the like may be applied for molding.

The material of the molded body is not particularly limited, and may be, for example, organic fiber or inorganic fiber. Exemplary organic fibers include vegetable fiber, animal fiber, regenerated fiber, semi-synthetic fiber, and synthetic fiber, and these fibers may be used singly or in combination. Exemplary inorganic fibers include glass fiber, carbon fiber, ceramic fiber and whisker, and these fibers may be used singly or in combination. Metal fiber can also be used. The vegetable fiber may be cotton or hemp (flax, rami). The animal fiber may be silk, wool (cashmere, wool, mohair, camel). The regenerated fiber may be rayon or cupra. The semi-synthetic fiber may be acetate, triacetate, or promix. Exemplary synthetic fibers include nylon, aramid, acrylic, vinylon, vinylidene, polyvinyl chloride, polyester, polyethylene, polypropylene, benzoate, polychlal, phenols, and polyurethane. In addition to the above-listed fibers, the vegetable fibers further include wood pulp, such as broadleaf free pulp or conifer pulp, straw pulp, bamboo pulp, kenaf pulp, and any other arbor or herb. Pulp fibers produced from wastepaper or waste sheets are also included. The types of the above-listed fibers are defined according to Seni Hand-bukku (Fiber Handbook, 1993 edition, Japan Chemical fiber Association).

Although the molded body described above uses fiber, the molded body of the present invention may be in a form other than fiber, using a material constituting the above fibers. The molded body of the present invention may be composed of only the conductive composition of the present invention, or may be the conductive polymer itself. The molded body of the present invention may be composed of a single constituent or a plurality of constituents as long as it contains at least one of the above-listed chemical constituents.

As descried above, the present invention can extremely increase, for example, the film formability of conductive polymer and lead to a wide range of applications, such as for giving plastics conductivity and to electrochemical elements for solid capacitor electrolytes or secondary battery electrolytes, anticorrosion or anticontamination paints using a chemical reaction of the composition, display elements using doping/dedoping, actuators and other electromechanical conversion elements, electrooptic conversion elements including solar cells and polymer LEDs, and FETs and other semiconductor elements, as described above.

As mentioned above, the conductive composition of the present invention can be used for various purposes. For example, the composition can be used for, but not limited to: (1) forming a film by coating (producing conductive sheets, antistatic, or aluminium solid capacitors, etc.); (2) using as a conductive ink to print electronic circuits by, for example, an ink-jet technique (producing organic transistors or the like); and (3) forming conductive fibers by impregnating fibers with the conductive composition.

Even for only electronics, the conductive composition can be used for rigid printed wiring boards partially coated with the conductive composition, flexible printed wiring boards partially coated with the conductive composition, rigid flex printed wiring board partially coated with the conductive composition, and so forth.

<Conductive Gel Composition>

A conductive gel composition according to the present invention contains the conductive composition and a gelling agent, specifically contains a conductive polymer, an ionic liquid, and a gelling agent, and at least part of the conductive polymer is dispersed and/or dissolved in the ionic liquid. By gelating the ionic liquid containing conductive polymer part of which is at least partially dispersed or dissolved, a conductive gel composition having a high conductivity can be produced.

In the conductive gel composition of the present invention, it is preferable that at least part of the conductive polymer be dissolved in the ionic liquid from the viewpoint of increasing the conductivity of the conductive gel composition.

In the conductive gel composition of the present invention, it is preferable that the concentration of the conductive polymer in the ionic liquid is at least 0.2 times as high as the saturated concentration of the conductive polymer in the ionic liquid, from the viewpoint of further increasing the conductivity of the conductive gel composition.

If the conductive polymer is dissolved in the ionic liquid, the viscosity of the solution is generally increased as in the case where a polymer is dissolved in a solvent. It is generally considered that the electrical conduction in a solution or a conductive gel composition is due to ionic conduction. Since the ionic conduction is largely subject to molecule motion, liquid or gel having a low viscosity exhibits a low specific resistance, and the specific resistance increases as the viscosity is increased. Therefore, if the viscosity is increased by dissolving a conductive polymer, the specific resistance may not be reduced effectively. In a system composed of only an ionic liquid and a conductive polymer, it is generally preferable that the concentration of the conductive polymer in the ionic liquid be at least 0.2 times, more preferably at least 0.5 times and still more preferably at least 0.6 times, as high as the saturated concentration of the conductive polymer in the ionic liquid, though the degree of the reduction in specific resistance by dissolution depends on the types of polymer and ionic liquid.

However, the conductive gel composition of the present invention is not simply composed of an ionic liquid and a conductive polymer, but further contains a third component or a gelling agent. Specifically, by gelating the composition, the composition exhibits an increased viscosity and accordingly an increased specific resistance. In such a ternary system, the specific resistance, mechanical strength, and flexibility of the conductive gel composition can be controlled by adjusting the degree of gelation. Thus, the tolerance to reduce the specific resistance by dissolving the conductive polymer expands in comparison with the composition composed of an ionic liquid and a conductive polymer. In general, the concentration of the conductive polymer in the ionic liquid is preferably at least 0.2 times as high as the saturated concentration of the conductive polymer in the ionic liquid, depending on the types of polymer and ionic liquid.

If the concentration of the conductive polymer in the ionic liquid is less than 0.2-times as high as the saturated concentration, the reduction of the specific resistance (electrical resistivity) is small at the same temperature because the dissolved conductive polymer increases the viscosity.

(Gelling Agent)

The gelling agent used in the conductive gel composition of the present invention preferably contains, but not limited to, at least two polar groups or at least two reactive functional groups. The polar group used herein refers to a functional group having a polarity, such as hydroxy, halide, carbonyl, carboxyl, ether, ester, amido, amino, acid amido, sugar amido, or vinyl. The two polar groups may be the same or different. The reactive functional group used herein refers to a functional group that cross-links molecular chains of the gelling agent by a chemical reaction. Exemplary reactive functional groups include isocyanate, groups having an unsaturated double bond, nucleophilic groups having an active hydrogen, epoxy, amine, and carboxyl. The isocyanate group reacts with a nucleophilic group having an active hydrogen to form a crosslink; a group having an unsaturated double bond reacts with a nucleophilic group having an active hydrogen to form a crosslink; the epoxy group reacts with the amine group or the carboxyl group to form a crosslink. The gelling agent having at least two polar groups or at least two reactive functional groups form an intermolecular bond, such as hydrogen bond, between the polar groups, or a covalent bond between the reactive functional groups, thus forming a three-dimensional network. The three-dimensional network facilitates the gelation of the ionic liquid in which part of the conductive polymer is dissolved. It is confirmed through a dark-field optical microscope that the conductive gel composition is produced by forming the three-dimensional network in the gelling agent.

Exemplary compound having at least two polar groups include pentaerytriol, β-D-glucose, α-cyclodextrin, polyvinyl alcohol, polyvinyl-based polymer (polyvinylidene fluoride, poly(vinylidene fluoride)-hexafluoropropylene copolymer, etc.), polyether-based polymer (polyethylene oxide derivatives, etc.), polyester-based polymer, polyurethane-based polymer, polyamide-based polymer, polyacrylonitrile-based polymer, polycarbonate-based polymer, protein (glucose oxidase, etc.), polysaccharides, sugar derivatives, and molecular aggregates (bilayer films made of C₈AzoC₁₀N⁺Br⁻ or diazoalkylammonium salts). Exemplary compounds having at least two reactive functional groups include isocyanate compounds having at least two isocyanate groups, compounds having at least two unsaturated double bonds, compounds having at least two nucleophilic groups including active hydrogens, epoxy compounds having at least two epoxy groups, amine compounds having at least two amine groups, and carboxy compounds having at least two carboxyl groups.

In the conductive gel composition of the present invention, the concentration of the gelling agent in the ionic liquid is preferably in the range of 0.03 to 0.5 g/mL. A concentration of less than 0.03 g/mL results in insufficient gelation, and a concentration of more than 0.5 g/mL results in an inelastic, inflexible, hard conductive gel composition whose conductivity is reduced (hence, the specific resistance is increased). Accordingly, the concentration is more preferably in the range of 0.05 to 0.4 g/mL.

<Method for Producing Conductive Gel Composition>

A method for producing the conductive gel composition of the present invention preferably includes, but not limited to, the dissolving step of dissolving at least part of a conductive polymer in an ionic liquid; and the gelating step of gelating the ionic liquid in which part of the conductive polymer is dissolved with a gelling agent. Thus, the ionic liquid in which part of the conductive polymer is dissolved can be gelated directly, thus producing a conductive gel composition having high conductivity.

In the step of dissolving at least part of a conductive polymer in an ionic liquid, the conductive polymer is added to a predetermined volume of ionic liquid. The liquid is heated to a temperature less than the boiling point of the ionic liquid (for example, 150° C.) and mixed with stirring to dissolve the conductive polymer in the ionic liquid. The undissolved conductive polymer may be filtered out through, for example, a filter to prepare the ionic liquid in which the conductive polymer is completely dissolved.

The gelating step of gelating the ionic liquid in which at least part of the conductive polymer is dissolved with a gelling agent may preferably include, but not limited to, the step of dispersing or dissolving the gelling agent in the ionic liquid, depending on the type of gelling agent. Such a gelling agent may be a gelling agent having high compatibility with or affinity for the ionic liquid, and may be, for example, a compound having at least two polar groups that are compatible with at least either the cation or the anion of the ionic liquid. Exemplary such gelling agents include pentaerytriol, β-D-glucose, α-cyclodextrin, polyvinyl alcohol, polyvinyl-based polymer (polyvinylidene fluoride, poly(vinylidene fluoride)-hexafluoropropylene copolymer, etc.), polyether-based polymer (polyethylene oxide derivatives, etc.), polyester-based polymer, polyurethane-based polymer, polyamide-based polymer, polyacrylonitrile-based polymer, polycarbonate-based polymer, protein (glucose oxidase, etc.), polysaccharides, sugar derivatives, molecular aggregates (bilayer films made of C₈AzoC₁₀N⁺Br⁻ or diazoalkylammonium salts).

The gelating step of gelating the ionic liquid in which at least part of the conductive polymer is dissolved with the gelling agent may preferably include the step of preparing a first gelling agent having at least two first reactive functional groups and a second gelling agent having at least two second reactive functional groups; the step of dissolving or dispersing the first gelling agent and the second gelling agent in the ionic liquid in which at least part of the conductive polymer is dissolved; and the step of polymerizing the first gelling agent with the second gelling agent, depending on the type of gelling agent. By polymerizing the first gelling agent with the second gelling agent, the ionic liquid in which at least part of the conductive polymer is dissolved can be easily gelated. In the step of dissolving or dispersing the first gelling agent and the second gelling agent in the ionic liquid, the order of dissolution or dispersion is not particularly limited. However, it is unfavorable that raw materials of the first gelling agent and the second gelling agent are directly mixed, because a rapid reaction could occur to solidify the gelling agents directly.

Exemplary combinations of the first gelling agent and the second gelling agent preferably includes: (a) a compound having at least two isocyanate groups and a compound having at least two nucleophilic groups including active hydrogens; (b) a compound having at least two unsaturated double bonds and a compound having at least two nucleophilic groups including active hydrogens; (C) an epoxy compound having at least two epoxy groups and polyamine and/or an acid anhydride.

In combination (a), the compound having at least two isocyanate groups and the compound having at least two nucleophilic groups are polymerized by polyaddition reaction, and thus the ionic liquid in which at least part of the conductive polymer is dissolved gelates. Exemplary compounds having at least two isocyanate groups include, for example, 2,4-toluenediisocyanate, 4,4′-diphenylenediisocyanate, hexamethylenediisocyanate, hydrogenated 4,4′-diphenylenediisocyanate, hexamethylenediisocyanate, hexamethylenediisocyanate trimer, and isocyanate ethyl methacrylate polymer. Exemplary compounds having at least two nucleophilic groups including active hydrogens include polyol compounds such as diols, triols, and tetraols, polyamines such as diamines, triamines, and tetraamines, and polycarboxylic acids such as dicarboxylic acids, tricarboxylic acids, and tetracarboxylic acids. The compounding ratio of the compound having at least two isocyanate groups being the first gelling agent to the compound having at least two nucleophilic groups including active hydrogens being the second gelling agent is preferably, but not limited to, 2:1 to 1:2 in terms of chemical equivalent. In addition, the total concentration of the first gelling agent and the second gelling agent in the ionic liquid is preferably in the range of 0.05 to 0.4 g/mL.

In order to promote the polyaddition reaction efficiently, a catalyst may be used. Such a catalyst may preferably be tin-based catalyst (dibutyltin dilaurylate) and/or amine-based catalyst that are used to synthesize polyurethane. The amount of catalyst is preferably in the range of 0.1 to 5 mass percent relative to the total of the compound having at least two isocyanate groups being first gelling agent and the compound having at least two nucleophilic groups including active hydrogens being the second gelling agent, and more preferably in the range of 0.2 to 2 mass percent.

In combination (b), the compound having at least two unsaturated double bonds and the compound having at least two nucleophilic groups including active hydrogens are polymerized by Michael addition reaction, and thus the ionic liquid in which at least part of the conductive polymer is dissolved gelates. The unsaturated double bond is not particularly limited as long as it can cause Michael addition reaction with the nucleophilic groups including active hydrogens. Preferred unsaturated double bonds include α,β-unsaturated carbonyl groups, α,β-unsaturated sulfonyl groups, and α,β-nitrile groups. Among these more preferred are α,β-unsaturated carbonyl groups. The compound having at least two nucleophilic group including active hydrogens is the same as in the description of combination (a). The compounding ratio of the compound having at least two unsaturated double bonds being the first gelling agent to the compound having at least two nucleophilic groups including active hydrogens being the second gelling agent is preferably, but not limited to, 2:1 to 1:2 in terms of chemical equivalent. In addition, the total concentration of the first gelling agent and the second gelling agent in the ionic liquid is preferably in the range of 0.05 to 0.4 g/mL.

In combination (c), the epoxy compound having at least two epoxy groups and a polyamine and/or an acid anhydride are polymerized to produce a gelling agent having at least two crosslinking points. Exemplary epoxy compounds include, but not particularly limited to, bisphenol A-based epoxy compounds, bisphenol F-based epoxy compounds, novolak epoxy compounds, halogenated epoxy compounds, and modified bisphenol A-based epoxy compounds. Exemplary polyamines include diamines, triamines, and tetraamines. The amine may be a primary amine, a secondary amine, or a tertiary amine. It may also be an aliphatic amine or an aromatic amine. Exemplary acid anhydrides include aromatic acid anhydrides, alicyclic acid anhydrides, aliphatic acid anhydrides, and halogenated acid anhydrides. The compounding ratio of the epoxy compound being the first gelling agent to the polyamine and/or acid anhydride being the second gelling agent is preferably 2:1 to 1:2 in terms of chemical equivalent. The total concentration of the first gelling agent and the second gelling agent is preferably in the range of 0.05 to 0.4 g/mL.

### EXAMPLES

(Ionic Liquid)

The ionic liquids used in the present invention will first be described. If a synthesizing method is described for a material, the material synthesized by the method was used; if no synthesizing method is described, a commercially available material was used. The molecular formulas, physical properties, and abbreviations (ILS-1 to ILS-17) of the ionic liquids used will be shown below. In the formulas, Im represents imidazolium, and Py represents pyridinium.

(ILS-1) (1-C₂H₅-3-C₂H₅-Im)⁺(p-CH₃—C₆H₄SO₃)⁻

In a dried 200 mL round-bottom flask were placed 4.02 g (41.7 mmol) of N-ethylimidazole and 20 mL of DMF, followed by stirring well. Under ice cooling, 8.35 g (41.7 mmol) of ethyl p-toluenesulfonate was added to the flask rapidly, followed by stirring for another 23 hours. The reacted liquid was dripped into 200 mL of ice-cooled ether. The ether was removed by decantation and 8.1 g of yellow liquid was recovered. The yield was 65.5%. The recovered liquid was identified by its ¹H-NMR spectrum. The resulting product had a glass transition temperature (Tg) of −59° C. The chemical formula is shown in Formula (1).

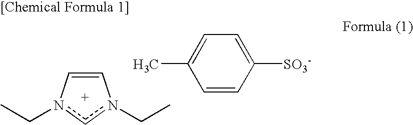

[Spectrum Data]: 500 MHz, ¹H-NMR (DMSO-d₆)

σ=1.35 (triplet, J=5 Hz, 3H), 2.23 (singlet, 3H), 4.15 (quarlet, J=5 Hz, 2H), 7.06 (doublet, J=5 Hz, 2H), 7.44 (doublet, J=5 Hz, 2H), 7.74 (singlet, 2H), 9.04 (singlet, 3H).

(ILS-2) (1-CH₃-3-C₂H₅-Im)⁺(p-CH₃—C₆H₄SO₃)⁻

ILS-2 was synthesized in the same manner as above. The product was yellow liquid and the yield was 74.4%. The recovered liquid was identified by its ¹H-NMR spectrum. The resulting product had a glass transition temperature (Tg) of −85.7° C. and a melting point of −12.7° C. The chemical formula is shown in Formula (2).

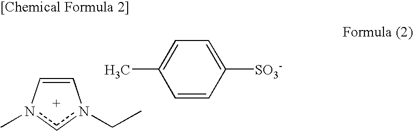

[Spectrum Data]: 500 MHz, ¹H-NMR (DMSO-d₆)

σ=1.33 (triplet, J=5 Hz, 3H), 2.22 (singlet, 3H), 3.77 (singlet, 3H), 4.12 (quarlet, J=5 Hz, 2H), 7.06 (doublet, J=5 Hz, 2H), 7.44 (doublet, J=5 Hz, 2H), 7.65 (singlet, 2H), 7.72 (singlet, 2H), 9.08 (singlet, 3H).

(ILS-3) (1-CH₂═CH-Im)⁺(p-CH₃—C₆H₄SO₃)⁻

ILS-3 was synthesized in the same manner as above. The product was white solid and had a melting point of −97° C. The chemical formula is shown in Formula (3).

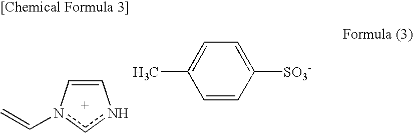

(ILS-4) (1-nC₄H₉-3-CH₃-Im)⁺(BF₄)⁻

Colorless liquid, melting point −71° C., produced by Koei Chemical. The chemical formula is shown in Formula (4).

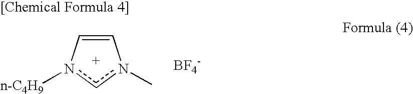

(ILS-5) (1-C₂H₅-3-CH₃-Im)⁺(BF₄)⁻

Colorless liquid, melting point −87° C., produced by Koei Chemical. The chemical formula is shown in Formula (5).

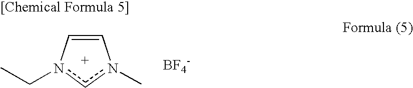

(ILS-6) (1-C₂H₅-3-CH₃-Im)⁺((CF₃SO₂)₂N)⁻

Colorless liquid (mp: −18.2° C.), produced by Koei Chemical. The Chemical formula is shown in Formula (6).

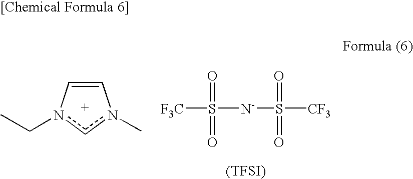

((CF₃SO₂)₂N)— shown in Formula (6) is bis(trifluoromethylsulfonyl)imide anion (TFSI).

(ILS-7) (1-C₂H₅-Im)⁺(C₆H₅SO₃)⁻

In 50 mL of ethanol was dissolved 4.02 g (41.7 mmol) of N-ethylimidazole. Then, 8.35 g (41.7 mmol) of p-toluenesulfonic acid monohydrate was quickly added to the ethanol solution of N-ethylimidazole, followed by stirring for 23 hours. After ethanol was evaporated in an evaporator, the remaining reacted liquid was dripped into 200 mL of dry ice-cooled ether. The mixture was quickly drawn through a suction funnel with a glass filter to separate out solid matter on the glass filter. Thus 8.10 g of product was recovered with a yield of 65.5%. The product was identified as 1-ethyl-imidazolium-p toluenesulfonate by its ¹H-NMR spectrum. The product was colorless transparent liquid and had a glass transition temperature of −65.1° C. and a melting point of −9.5° C. The chemical formula is shown in Formula (7).

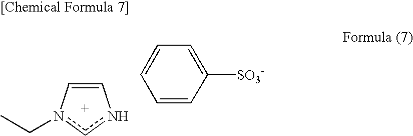

[Spectrum Data]: 500 MHz, ¹H-NMR (DMSO-d₆, σ)

σ=1.35 (triplet, J=5 Hz, 3H), 2.23 (singlet, 3H), 4.15 (quarlet, J=5 Hz, 2H), 7.06 (doublet, J=5 Hz, 2H), 7.44 (doublet, J=5 Hz, 2H), 7.74 (singlet, 2H), 9.04 (singlet, 1H).

(ILS-8) (1-C₂H₅-3-CH₃-Im)⁺(C₃F₄H₃ SO₄⁻)

Colorless liquid, melting point −65.1° C., produced by Koei Chemical. The chemical formula is shown in Formula (8).

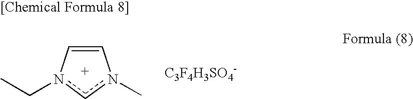

(ILS-9) (1-C₂H₅-Im)⁺(p-CH₃—C₆H₄SO₃)⁻

ILS-9 was synthesized in the same manner as ILS-7. The product was colorless transparent liquid, and had a glass transition temperature of 327.5° C. and a melting point of 0° C. The chemical formula is shown in Formula (9).

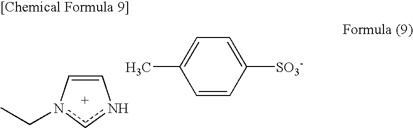

(ILS-10) (1-CH₃-Im)⁺(p-CH₃—C₆H₄SO₃)⁻

ILS-9 was synthesized in the same manner as ILS-7. The product was colorless transparent liquid and had a glass transition point of 331° C. and a melting point of −14.4° C. The chemical formula is shown in Formula (10).

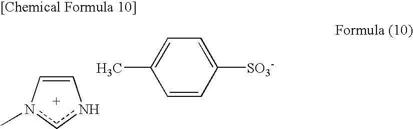

(ILS-11) (1-CH₃-3-C₂H₅-Im)⁺(CF₃SO₃)⁻

Colorless liquid, melting point −9° C., produced by Kanto Kagaku. The chemical formula is shown in Formula (11).

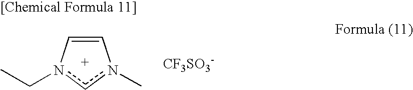

(ILS-12) (1-C₂H₅-Im)⁺(CH₃CH₂CH₂CH₂SO₃)⁻

First, 5.30 g (55.1 mmol) of N-ethylimidazole was dissolved in 50 mL of acetone. Then, 7.61 g (55.9 mL) of propane sultone was dissolved in 100 mL of acetone. The solution was dripped into the acetone solution of N-ethylimidazole at room temperature, followed by a reaction with stirring at room temperature for 91 hours. The resulting reaction mixture was drawn through a suction funnel with a glass filter to separate out the product on the glass filter. The product was sufficiently washed with an excessive amount of acetone and vacuum-dried. Thus 1.42 g of product was produced with a yield of 11.1%. The product was identified as 1-(N-ethylimidazolio)butane-4-sulfonate by its ¹H-NMR spectrum. Its melting point was −10° C. according to differential scanning calorimetry (DSC). The chemical formula is shown in Formula (12).

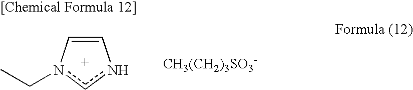

[Spectrum Data]: 500 MHz, ¹H-NMR (DMSO-d₆)

σ=1.36 (triplet, 3H), 1.48 (triplet, 2H), 1.84 (triplet, 2H), 2.36 (triplet, 2H), 4.13 (multiplet, 4H), 7.77 (d. d. 2H), 9.20 (singlet, 1H).

(ILS-13) (1-nC₄H₉-Im)⁺(p-CH₃—C₆H₄SO₃)⁻

In 20 mL of DMF (dimethylformamide) was dissolved 3.80 g (30.6 mmol) of N-butylimidazole. Then, 5.20 g (30.6 mmol) of p-toluenesulfonic acid monohydrate was quickly added to the DMF solution of N-butylimidazole under ice cooling, followed by stirring for 23 hours. The reaction liquid was dripped into 200 mL of dry ice-cooled ether. The mixture was drawn through a suction funnel with a glass filter to separate out solid matter. Thus 6.40 g of white solid was recovered with a yield of 70.6%. The recovered product was identified as 1-butyl-imidazolium p-toluenesulfonate by its ¹H-NMR spectrum. The resulting imidazolium salt had a glass transition temperature (Tg) of −38.4° C. and a melting point of 2.6° C. The chemical formula is shown in Formula (13).

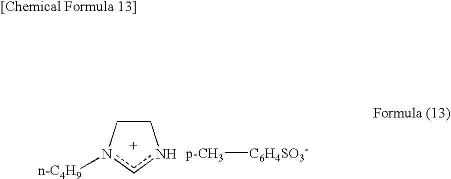

[Spectrum Data]: 500 MHz, ¹H-NMR (DMSO-d₆)

σ=0.84 (triplet, J=5 Hz, 3H), 1.16 (multiplet, 2H), 1.71 (multiplet, 2H), 2.23 (singlet, 3H), 4.11 (trilet, J=5 Hz, 2H), 7.07 (doublet, J=5 Hz, 2H), 7.44 (doublet, J=5 Hz, 2H), 7.60 (singlet, 1H), 7.71 (singlet, 1H), 9.04 (singlet, 3H).

(ILS-14) (1-nC₄H₉-2-CH₃-3-CH₃-Im)⁺(C₂H₅OC₂H₄OSO₃)⁻, brown liquid, melting point −4.2° C. The chemical formula is shown in Formula (14).

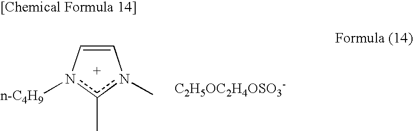

(ILS-15) (1-nC₄H₉-3-CH₃-Im)⁺(CHF₂CF₂CF₂CF₂CH₂SO₃)⁻, yellow liquid, melting point −62° C. The chemical formula is shown in Formula (15).

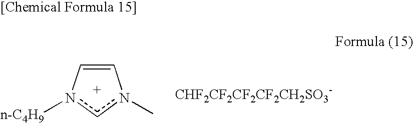

(ILS-16) (1-nC₆H₁₃-3-CH₃-Im)⁺(PF₆)⁻

Colorless liquid, melting point −73° C., produced by Kanto Kagaku. The chemical formula is shown in Formula (16).

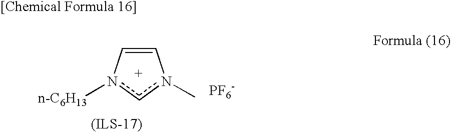

Brown liquid, melting point −61° C. The chemical formula is shown in Formula (17).

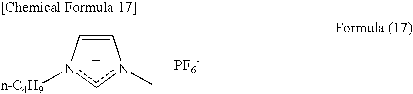

(Conductive Polymer)

### Synthesis Example 1

### Polypyrrole Polymerization Method

For the polymerization, the method described in Synthetic Metals, 79, (1996), pp. 17-22 was referred to.

An aqueous solution containing 20.1 g of pyrrole in 100 mL of 3.3 mass % surfactant (sodium alkylbenzenesulfonate) was added to an aqueous solution of oxidizing agent containing 2.2 g of iron (III) sulfate in 100 mL of 3.3 mass % surfactant (sodium alkylbenzenesulfonate), followed by stirring at 80° C. for 24 hours. The mixture was filtered through a filter (No. 2, produced by Toyo Roshi) and the residue was washed and dried to yield polypyrrole.

### Synthesis Example 2

### Poly(3,4-ethylenedioxythiophene) Polymerization Method

For the polymerization, the method described in Example 1 of Japanese Unexamined Patent Application Publication No. 1-313521 was referred to.

In an acetonitrile solution of 8.11 g of iron (III) chloride in 100 mL of acetonitrile was added 2.84 g of 3,4-ethylenedioxythiophene, followed by stirring well at 0° C. for 24 hours. The mixture was filtered through a filter (No. 2, produced by Toyo Roshi) and the residue was washed and fried to yield poly(3,4-ethylenedioxythiophene).

<Conductive Composition>

### Example 1

### Dissolving Polypyrrole in Ionic Liquid

In a well-dried 100 cm³ two-neck flask equipped with a stirring paddle and a Liebig reflux condenser, 0.50 g of polypyrrole of Synthesis Example 1 was added to 10 mL of ionic liquid 1 (ILS-1) and stirred at 150° C. to be dissolved in the ionic liquid. The liquid immediately turned dark purple. After the liquid was heated at 150° C. for 30 minutes and cooled to room temperature, the ionic liquid was filtered. The undissolved polypyrrole separated out on the filter (No. 2, produced by Toyo Roshi) was washed with water and methanol and dried. The dried product weighed 0.30 g.

Although the filtrate was then centrifuged, nothing was separated out. This suggests that about 0.2 g of polypyrrole was probably dissolved in 10 mL of ionic liquid 1 (ILS-1).

In the Description, the “saturated concentration in ionic liquid” is defined from the mass of dissolved conductive polymer, not remaining on the filter even by such filtration. In Example 1, the “saturated concentration in ionic liquid” is 0.2 g/10 mL.

In order to confirm that the presumption of dissolution was true, 0.05 g, 0.1 g, 0.15 g, 0.2 g, and 0.25 g of polypyrrole of Synthesis Example 1 were dissolved separately in 10 mL of ionic liquid, and the ultraviolet-visible absorption spectrum of each solution was measured. While the absorption intensity of the ultraviolet-visible absorption spectrum was proportional to the concentration of the solute polypyrrole until 0.15 g of polypyrrole was dissolved, the absorption intensities for 0.2 and 0.25 g of polypyrrole were not proportional to the concentrations of the solute polypyrrole. The solubility of polypyrrole in ionic liquid 1 (ILS-1) was thus determined to be about 15 g/(1000 mL) to 20 g/(1000 mL).

### Example 2

An experiment was conducted under the same conditions as in Example 1, except that ionic liquid 2 (ILS-2) was substituted for ILS-1. The saturated concentration of polypyrrole in ILS-2 was 0.15 g/10 mL.

### Example 3

An experiment was conducted under the same conditions as in Example 1, except that ionic liquid 3 (ILS-3) was substituted for ILS-1. The saturated concentration of polypyrrole in ILS-3 was 0.04 g/10 mL.

### Example 4

An experiment was conducted under the same conditions as in Example 1, except that ionic liquid 4 (ILS-4) was substituted for ILS-1. The saturated concentration of polypyrrole in ILS-4 was 0.01 g/10 mL.

### Example 5

An experiment was conducted under the same conditions as in Example 1, except that ionic liquid 5 (ILS-5) was substituted for ILS-1. The saturated concentration of polypyrrole in ILS-5 was 0.01 g/10 mL.

### Example 6

An experiment was conducted under the same conditions as in Example 1, except that ionic liquid 6 (ILS-6) was substituted for ILS-1. The saturated concentration of polypyrrole in ILS-6 was 0.01 g/10 mL.

### Example 7

An experiment was conducted under the same conditions as in Example 1, except that ionic liquid 7 (ILS-7) was substituted for ILS-1. The saturated concentration of polypyrrole in ILS-7 was 0.05 g/10 mL.

### Example 8

An experiment was conducted under the same conditions as in Example 1, except that ionic liquid 8 (ILS-8) was substituted for ILS-1. The saturated concentration of polypyrrole in ILS-8 was 0.05 g/10 mL.

### Example 9

An experiment was conducted under the same conditions as in Example 1, except that ionic liquid 9 (ILS-9) was substituted for ILS-1. The saturated concentration of polypyrrole in ILS-9 was 0.10 g/10 mL.

### Example 10

An experiment was conducted under the same conditions as in Example 1, except that ionic liquid 10 (ILS-10) was substituted for ILS-1. The saturated concentration of polypyrrole in ILS-10 was 0.10 g/10 mL.

### Example 11

An experiment was conducted under the same conditions as in Example 1, except that ionic liquid 11 (ILS-11) was substituted for ILS-1. The saturated concentration of polypyrrole in ILS-1 was 0.05 g/10 mL.

### Example 12

An experiment was conducted under the same conditions as in Example 1, except that ionic liquid 12 (ILS-12) was substituted for ILS-1. The saturated concentration of polypyrrole in ILS-12 was 0.05 g/10 mL.

### Example 13

An experiment was conducted under the same conditions as in Example 1, except that ionic liquid 13 (ILS-13) was substituted for ILS-1. The saturated concentration of polypyrrole in ILS-13 was 0.10 g/10 mL.

### Example 14

An experiment was conducted under the same conditions as in Example 1, except that ionic liquid 14 (ILS-14) was substituted for ILS-1. The saturated concentration of polypyrrole in ILS-14 was 0.05 g/10 mL.

### Example 15

An experiment was conducted under the same conditions as in Example 1, except that ionic liquid 15 (ILS-15) was substituted for ILS-1. The saturated concentration of polypyrrole in ILS-15 was 0.05 g/10 mL.

### Example 16

An experiment was conducted under the same conditions as in Example 1, except that ionic liquid 16 (ILS-16) was substituted for ILS-1. The saturated concentration of polypyrrole in ILS-16 was 0.01 g/10 mL.

### Example 17

An experiment was conducted under the same conditions as in Example 1, except that ionic liquid 17 (ILS-17) was substituted for ILS-1. The saturated concentration of polypyrrole in ILS-17 was 0.03 g/10 mL.

### Example 18

### Dissolving Poly(3,4-Ethylenedioxythiophene) In Ionic Liquid

An experiment was conducted under the same conditions as in Example 1, except that poly(3,4-ethylenedioxythiophene) was substituted for polypyrrole. The saturated concentration of poly(3,4-ethylenedioxythiophene) in ILS-1 was 0.15 g/10 mL.

### Example 19

An experiment was conducted under the same conditions as in Example 18, except that ionic liquid 2 (ILS-2) was substituted for ILS-1. The saturated concentration of poly(3,4-ethylenedioxythiophene) in ILS-2 was 0.15 g/10 mL.

### Example 20

An experiment was conducted under the same conditions as in Example 18, except that ionic liquid 3 (ILS-3) was substituted for ILS-1. The saturated concentration of poly(3,4-ethylenedioxythiophene) in ILS-2 was 0.15 g/10 mL.

<Conductive Molded Body>

### Example 21

A filter (No. 2, produced by Toyo Roshi) was immersed in the Example 1 product “polypyrrole-dissolving ionic liquid 1 (ILS-1)” immediately after being filtered to separate out polypyrrole through a filter, subsequently immersed in water, and then dried. Polypyrrole precipitated in the filter, and thus a conductive molded body constituted of the filter and polypyrrole was produced.

### Example 22

A cotton cloth was immersed in the Example 1 product “polypyrrole-dissolving ionic liquid 1 (ILS-1)”, subsequently immersed in water, and then dried. Polypyrrole precipitated in the cotton cloth, and thus a conductive molded body constituted of the cotton cloth and polypyrrole was produced.

### Example 23

A solution having a concentration of 0.65 times as high as the saturated concentration (0.2 g/10 mL) of Example 1 was prepared in the same manner as in Example 1. Specifically, the solution was prepared by dissolving 0.13 g of polypyrrole in 10 mL of ILS-1 in the same manner as in Example 1. It was presumed that polypyrrole was completely dissolved in the solution as confirmed by the ultraviolet-visible absorption in Example 1. A conductive molded body constituted of a cotton cloth and polypyrrole was produced in the same manner as in Example 22, except that the solution having a concentration 0.65 times as high as the saturated concentration was used.

### Comparative Example 1

### Dissolving Polypyrrole in Acetonitrile

In a well-dried 100 cm³ two-neck flask equipped with a stirring paddle and a Liebig reflux condenser, a specified amount 0.03 g of polypyrrole was added to 6 mL of acetonitrile and stirred at 150° C. However, polypyrrole was not dissolved in acetonitrile.

### Comparative Example 2

### Dissolving Poly(3,4-Ethylenedioxythiophene) in Acetonitrile

In a well-dried 100 cm³ two-neck flask equipped with a stirring paddle and a Liebig reflux condenser, a specified amount 0.03 g of poly(3,4-ethylenedioxythiophene) was added to 6 mL of acetonitrile and stirred at 150° C. However, poly(3,4-ethylenedioxythiophene) was not dissolved in acetonitrile.

<Conductive Gel Composition>

The conductive gel composition will now be described in detail which is prepared by gelating a conductive polymer-dissolving ionic liquid with a gelling agent. In the following examples and comparative examples, the conductivities of the ionic liquid in which at least part of a conductive polymer is dissolved and the conductive gel composition prepared by gelating this ionic liquid were evaluated by measuring their specific resistances. Conductivity is the reciprocal of the specific resistance; hence, the lower the specific resistance, the higher the conductivity.

Before the gelation of a conductive polymer-dissolving ionic liquid with a gelling agent, a conductive polymer polypyrrole or polyaniline was dissolved in an ionic liquid ethylmethylimidazolium p-toluenesulfonate (hereinafter referred to as EMImTsO), and the conductivity of the solution was measured by an ordinary method using two terminals (measuring instrument: Electro Chemical Analyzer, Model ALS608B, manufactured by BAS Inc.) in an atmosphere of 25° C. The polypyrrole used here was prepared by chemical polymerization using iron p-toluenesulfonate, and polyaniline produced by Aldrich (serial No. 42832) was used.

Samples were prepared by dissolving 0.05 g (concentration: 0.005 g/mL) or 0.1 g (concentration: 0.01 g/mL) of polypyrrole and polyaniline separately in 10 mL of EMImTsO. The saturated concentration of polypyrrole in EMImTsO is 0.01 g/mL and the saturated concentration of polyaniline in EMImTsO is 0.012 g/mL. Hence, the conductive polymers of those prepared solutions were completely dissolved in EMImTsO. The measured specific resistances were shown in Table 1.

TABLE 1

| | | | | | |
|---|---|---|---|---|---|
| Ionic liquid | EMImTsO | EMImTsO | EMImTsO⁾ | EMImTsO | EMImTsO |
| Conductive | — | Polypyrrole | Polypyrrole | Polyaniline | Polyaniline |
| polymer | | | | | |
| Conductive | 0 | 0.005 | 0.01 | 0.005 | 0.01 |
| polymer mass | | | | | |
| concentration | | | | | |
| (g/mL) | | | | | |
| Specific | 3 × 10³ | 7 × 10³ | 3 × 10² | 1.3 × 10⁴ | 1.8 × 10³ |
| resistance | | | | | |
| (Ω · cm) | | | | | |

The results clearly show that in either case using polypyrrole or polyaniline, the samples in which 0.005 g/mL of conductive polymer was dissolved exhibited higher specific resistances than sole EMImTsO. On the other hand, in either case using polypyrrole or polyaniline, the samples in which 0.01 g/mL of conductive polymer was dissolved exhibited lower specific resistances than sole EMImTsO.

It is known that the specific resistance of a liquid sample depends on the viscosity of the liquid so that the specific resistance increases as the viscosity is increased, When the concentration of conductive polymer was 0.005 g/mL, probably the specific resistance was increased because the viscosity was increased beyond the effect of reducing the specific resistance by adding the conductive polymer. Consequently, the specific resistance as a whole was probably increased. When the concentration of conductive polymer was 0.01 g/mL, probably the specific resistance was reduced because the conductive polymer was added beyond the effect of increasing the specific resistance by increasing the viscosity. Consequently, the specific resistance as a whole was reduced.

It is known that conductive gel compositions can also exhibit a variety of physical properties from being very soft to being mechanically strong and tough depending on the types and proportions of the gelling agent and liquid, and such properties are controlled according to the application. Accordingly, an object of the present invention is to provide a conductive gel composition that can exhibit higher conductivity when it is treated to obtain a mechanical strength or flexibility.

### Example 24

Using as the gelling agent tetrahydrofuran (hereinafter referred to as THF) solution in which poly(vinylidene fluoride)-hexafluoropropylene copolymer (hereinafter referred to as PFV-HFP) was dissolved, 10 mL of EMImTsO in which 0.05 g of polypyrrole was dissolved (polypyrrole concentration: 0.005 g/mL, r=(conductive polymer concentration: M)/(conductive polymer saturated concentration: M_{S})=0.5) was gelated to yield a conductive gel composition. The gelating conditions were set so that the PFV-HFP concentration in EMImTsO was 0.12 g/mL and the solution was heated at 60° C. for 3 hours in a reactor equipped with a reflux condenser to yield a homogenous solution. The resulting solution was applied onto a polyethylene terephthalate film (hereinafter referred to as PET film) with a doctor blade, and the THF was evaporated to yield a sheet of the conductive gel composition. The gel sheet was able to be free-standing even though it was removed from the PET film. The specific resistance of the resulting conductive gel composition was measured by the above-mentioned method using two terminals in an atmosphere of 25° C., and was 2×10⁴ Ω·cm. The results are shown in Table 2.

### Example 25

A conductive gel composition was prepared in the same manner as in Example 24, except that EMImTsO in which 0.01 g/mL of polypyrrole was dissolved (r=1.0) was substituted for EMImTsO in which 0.005 g/mL of polypyrrole was dissolved (r=0.5) and that the PFV-HFP concentration in EMImTsO was 0.1 g/mL. The resulting conductive gel composition had a specific resistance of 2×10³ Ω·cm. The results are shown in Table 2. The reason why the PFV-HFP concentration in EMImTsO was set at 0.1 g/mL was to prepare an independent gel sheet in the present example having substantially the same flexibility as the gel sheet prepared in Example 24.

### Example 26

A conductive gel composition was prepared in the same manner as in Example 24, except that EMImTsO in which 0.005 g/mL of polyaniline was dissolved (r=0.42) was substituted for EMImTsO in which 0.005 g/mL of polypyrrole was dissolved and that the PFV-HFP concentration in EMImTsO was 0.12 g/mL. The resulting conductive gel composition had a specific resistance of 4×10⁴ Ω·cm. The results are shown in Table 2. The reason why the PFV-HFP concentration in EMImTsO was set at 0.12 g/mL was the same as in Example 25.

### Example 27

A conductive gel composition was prepared in the same manner as in Example 24, except that EMImTsO in which 0.01 g/mL of polyaniline was dissolved (r=0.83) was substituted for EMImTsO in which 0.005 g/mL of polypyrrole was dissolved and that the PFV-HFP concentration in EMImTsO was 0.1 g/mL. The resulting conductive gel composition has a specific resistance of 5×10³ Ω·cm. The results are shown in Table 2. The reason why the PFV-HFP concentration in EMImTsO was set at 0.1 g/mL was the same as in Example 25.

### Comparative Example 3

A conductive gel composition was prepared in the same manner as in Example 24, except that EMImTsO was substituted for EMImTsO in which 0.005 g/mL of polypyrrole was dissolved and that the PFV-HFP concentration in EMImTsO was 0.15 g/mL. The resulting conductive gel composition had a specific resistance of 8×10⁴ Ω·cm. The results are shown in Table 2. The reason why the PFV-HFP concentration in EMImTsO was set at 0.15 g/mL was the same as in Example 25.

TABLE 2

| | Comparative | Example | Example | Example | Example |
|---|---|---|---|---|---|
| | Example 3 | 24 | 25 | 26 | 27 |
| Ionic liquid | EMImTsO | EMImTsO | EMImTsO | EMImTsO | EMImTsO |
| Conductive | — | Polypyrrole | Polypyrrole | Polyaniline | Polyaniline |
| polymer | | | | | |
| Gelling agent | PFV-HFP | PFV-HFP | PFV-HFP | PFV-HFP | PFV-HFP |
| Conductive | 0 | 0.005 | 0.01 | 0.005 | 0.01 |
| polymer mass | | | | | |
| concentration | | | | | |
| (g/mL) | | | | | |
| r*¹⁾ | 0 | 0.5 | 1.0 | 0.42 | 0.83 |
| Gelling agent | 0.15 | 0.12 | 0.1 | 0.12 | 0.1 |
| mass | | | | | |
| concentration | | | | | |
| (g/mL) | | | | | |
| Specific | 8 × 10⁴ | 2 × 10⁴ | 2 × 10³ | 4 × 10⁴ | 5 × 10³ |
| resistance | | | | | |
| (Ω · cm) | | | | | |

*¹⁾r = M/Mₛ

As clearly shown in Table 2, while the conductive gel composition using only EMImTsO had a specific resistance of 8×10⁴ Ω·cm, the conductive gel composition using EMImTsO in which 0.005 g/mL of polypyrrole was dissolved had a conductivity of 2×10⁴ Ω·cm and the conductive gel composition using EMImTsO in which 0.01 g/mL of polypyrrole was dissolved had a conductivity of 2×10³ Ω·cm. Also, the conductive gel composition using EMImTsO in which 0.005 g/mL of polyaniline was dissolved had a conductivity of 4×10⁴ Ω·cm, and the conductive gel composition using EMImTsO in which 0.01 g/mL of polyaniline was dissolved had a conductivity of 5×10³ Ω·cm. This shows that the conductive gel compositions prepared by gelating an ionic liquid containing a dissolved conductive polymer had higher conductivities than the conductive gel composition prepared by gelating only an ionic liquid.

### Example 28

A conductive gel composition was prepared in the same manner as in Example 24, except that EMImTsO in which 0.001 g/mL of polypyrrole was dissolved (r=0.1) was substituted for EMImTsO in which 0.005 g/mL of polypyrrole was dissolved and that PFV-HFP concentration in EMImTsO was 0.14 g/mL. The resulting conductive gel composition had a specific resistance of 7×10⁴ Ω·cm. The results are shown in Table 3. The reason why the PFV-HFP concentration in EMImTsO was set at 0.14 g/mL was the same as in Example 25.

### Example 29

A conductive gel composition was prepared in the same manner as in Example 24, except that EMImTsO in which 0.002 g/mL of polypyrrole was dissolved (r=0.2) was substituted for EMImTsO in which 0.005 g/mL of polypyrrole was dissolved and that the PFV-HFP concentration in EMImTsO was 0.13 g/mL. The resulting conductive gel composition had a specific resistance of 4×10⁴ Ω·cm. The results are shown in Table 3. The reason why the PFV-HFP concentration in EMImTsO was set at 0.13 g/mL was the same as in Example 25.

### Example 30

A conductive gel composition was prepared in the same manner as in Example 24, except that EMImTsO in which polypyrrole in an amount equivalent to 0.03 g/mL was dissolved (r=3.0) was substituted for EMImTsO in which 0.005 g/mL of polypyrrole was dissolved and that the PFV-HFP concentration in EMImTsO was 0.1 g/mL. The resulting conductive gel composition had a specific resistance of 8×10² Ω·cm. The results are shown in Table 3. In the present example, it is estimated that 0.01 g/mL of the polypyrrole in an amount equivalent to 0.03 g/mL in EMImTsO was dissolved in EMImTsO and the other portion of the polypyrrole, equivalent to 0.02 g/mL, was dispersed as particles in EMImTsO. The resulting conductive gel composition was free-standing. However the conductive gel composition had a low mechanical strength and a lower flexibility than the conductive gel composition prepared in Example 24.

### Example 31

A conductive gel composition was prepared in the same manner as in Example 30, except that the PFV-HFP concentration in EMImTsO was set at 0.12 g/mL. The resulting conductive gel composition had a specific resistance of 7×10³ Ω·cm. The results are shown in Table 3. The mechanical strength of this conductive gel composition was improved so that the conductive gel composition can form a strong gel, but the flexibility was lower than that of the conductive gel composition of Example 24 having a PFV-HFP concentration of 0.12 g/mL.

### Example 32

A conductive gel composition was prepared in the same manner as in Example 25 except that EMIm·((CF₃SO₂)₂N) (hereinafter referred to as EMImTFSI) was used as the ionic liquid instead of EMImTsO. The resulting conductive gel composition was able to be a free-standing flexible sheet, as in Example 25. The resulting conductive gel composition had a specific resistance of 3×10⁴ Ω·cm. This value was 15 times as high as the specific resistance in Example 25. The results are shown in Table 3. In the present example, EMImTFSI hardly dissolves polypyrrole, and only 0.002 g/mL of the polypyrrole in an amount of 0.01 g/mL (r=5.0) is dissolved in EMImTFSI. This shows that a conductive polymer soluble in the ionic liquid greatly contributes to the decrease in specific resistance (increase in conductivity).

### Example 33

The present example used a gelling agent other than the gelling agent (PFV-HEP) used in Examples 24 to 32. First, a catalyst, 100 ppm of dibutyltin dilaurate was added to EMImTsO in which 0.005 g/mL of polypyrrole (r=0.5) was dissolved, then polyoxyethylene glycerol (molecular weight: 1200) (hereinafter referred to as POEG) was added, and subsequently toluene diisocyanate (hereinafter referred to as TDI) was added in a molar ratio of 1:1 to prepare a mixed solution. POEG and TDI were mixed so that their total amount was 0.06 g/m L in EMImTsO. The mixed solution was allowed to stand at 80° C. for 30 minutes, and thus a conductive gel composition was obtained. The resulting conductive gel composition had a specific resistance of 1×10⁴ Ω·cm. The results are shown in Table 3.

TABLE 3

| | Example | Example | Example | Example | Example | Example |
|---|---|---|---|---|---|---|
| | 28 | 29 | 30 | 31 | 32 | 33 |
| Ionic liquid | EMImTsO | EMImTsO | EMImTsO | EMImTsO | EMImTFSI | EMImTsO |
| Conductive | Polypyrrole | Polypyrrole | Polypyrrole | Polypyrrole | Polypyrrole | Polypyrrole |
| polymer | | | | | | |
| Gelling agent | PFV-HFP | PFV-HFP | PFV-HFP | PFV-HFP | PFV-HFP | POEG, TDI |
| Conductive | 0.001 | 0.002 | 0.03 | 0.03 | 0.01 | 0.005 |
| polymer mass | | | | | | |
| concentration | | | | | | |
| (g/mL) | | | | | | |
| r*¹⁾ | 0.1 | 0.2 | 3.0 | 3.0 | 5.0 | 0.5 |
| Gelling agent | 0.14 | 0.13 | 0.1 | 0.12 | 0.1 | 0.06 |
| mass | | | | | | |
| concentration | | | | | | |
| (g/mL) | | | | | | |
| Specific | 7 × 10⁴ | 4 × 10⁴ | 8 × 10² | 7 × 10³ | 3 × 10⁴ | 1 × 10⁴ |
| resistance | | | | | | |
| (Ω · cm) | | | | | | |

*¹⁾r = M/Mₛ

As is clear from Examples 24 and 25 in Table 2 and Examples 28 and 29 in Table 3, it has been found that when r≧0.2 holds (that is, when the conductive polymer (polypyrrole) concentration in the ionic liquid (EMImTsO) is at least 0.2 times as high as the saturated concentration of the conductive polymer (polypyrrole)), the specific resistance can be reduced effectively. Also, it has been found that when r≧0.5 holds (that is, when the conductive polymer (polypyrrole) concentration in the ionic liquid (EMImTsO) is at least 0.5 times as high as the saturated concentration of the conductive polymer (polypyrrole)), the specific resistance can be reduced more effectively.

As is clear from Examples 24 and 25 in Table 2 and Examples 30 and 31 in Table 3, it has been found that the presence of undissolved polypyrrole fine powder in the ionic liquid (EMImTsO) degrades the mechanical properties of the conductive gel composition, but can reduce the specific resistance effectively.

As shown in Examples 24 to 33 in Tables 2 and 3, by appropriately combining the dissolved conductive polymer and the conductive polymer fine powder in the ionic liquid, resulting conductive gel compositions can exhibit different specific resistances, mechanical toughnesses, and flexibilities.

As described with reference to the examples and the comparative examples, the conductive gel composition prepared by gelating an ionic liquid containing an at least partially dissolved conductive polymer has a higher conductivity than the conductive gel composition prepared by gelating only an ionic liquid. The at least partially dissolved conductive polymer is extremely effective in reducing the specific resistance of the conductive gel composition without degrading the mechanical properties of the conductive gel composition.

As described above, the present invention can provide a conductive gel composition having a higher conductivity than known conductive gel compositions. The conductive gel composition having a high conductivity of the present invention can be widely used for solid electrolytes, biological electrodes, sensors, and the like.

For reference, some examples will be shown below which are conductive compositions containing a conductive polymer dispersed and/or dissolved in a fluorinated alcohol and conductive compositions containing a conductive polymer dispersed or dissolved in a mixed solvent of a fluorine alcohol and a chlorinated hydrocarbon.

### Referential Example 1

### Dissolving Polypyrrole in Hexafluoroisopropanol (Formal Name: 1,1,1,3,3,3-hexafluoro-2-propanol)

In a well-dried 100 cm³ two-neck flask equipped with a stirring paddle and a Liebig reflux condenser, 0.50 g of polypyrrole was added to 10 mL of hexafluoroisopropanol and stirred at 150° C. to dissolve the polypyrrole in the hexafluoroisopropanol. The liquid immediately turned dark purple. After heating the liquid at 150° C. for 30 minutes and cooling it to room temperature, the hexafluoroisopropanol was filtered. Polypyrrole separated out on the filter was washed with water and methanol and dried. The dried product weighed 0.39 g.

Then the filtrate was subjected to centrifugation, but nothing was separated out. It was therefore presumed that about 0.11 g of polypyrrole was dissolved in 10 mL of hexafluoroisopropanol.

In the Description, the “saturated concentration in fluorinated alcohol (hexafluoroisopropanol in the present example)” is defined from the mass of dispersed and/or dissolved conductive polymer not remaining on the filter even by filtration. In Referential Example 1, the “saturated concentration in fluorinated alcohol (hexafluoroisopropanol in the present example)” is 0.11 g/10 mL.

In order to confirm that the presumption of dissolution was true, 0.05 g, 0.1 g, 0.15 g, and 0.2 g of polypyrrole were dissolved separately in 10 mL of hexafluoroisopropanol, and the ultraviolet-visible absorption spectrum of each solution was measured. While the absorption intensity was proportional to the concentration of the solute polypyrrole until 0.1 g of polypyrrole was dissolved, the absorption intensities for 0.15 and 0.2 g of polypyrrole were not proportional to the concentrations of the solute. The solubility of polypyrrole in hexafluoroisopropanol was thus determined to be about 11 g/L (1000 mL).

### Referential Example 2

An experiment was conducted using a mixed solvent of hexafluoroisopropanol and chloroform (mass ratio=4:1) in the same manner as in Referential Example 1. The saturated concentration of polypyrrole in the mixed solvent of hexafluoroisopropanol and chloroform (mass ratio=4:1) was 0.16 g/10 mL.

### Referential Example 3

An experiment was conducted using 2,2,3,3-tetrafluoro-1-propanol in the same manner as Referential Example 1. The saturated concentration of polypyrrole in 2,2,3,3-tetrafluoro-1-propanol was 0.08 g/10 mL.

### Referential Example 4

An experiment was conducted using 2,2,3,4,4,4-hexafluoro-1-butanol in the same manner as Referential Example 1. The saturated concentration of polypyrrole in 2,2,3,3-tetrafluoro-1-propanol was 0.06 g/10 mL.

### Referential Example 5

### Dissolving Poly(3,4-Ethylenedioxythiophene) in Hexafluoroisopropanol (formal name: 1,1,1,3,3,3-hexafluoro-2-propanol)

In a well-dried 100 cm³ two-neck flask equipped with a stirring paddle and a Liebig reflux condenser, 0.50 g of poly(3,4-ethylenedioxythiophene) was dissolved in 10 mL of hexafluoroisopropanol. The liquid immediately turned dark purple. After being heated at 50° C. for 30 minutes and cooled to room temperature, the liquid was filtered. Poly(3,4-ethylenedioxythiophene pyrrole) separated out on the filter was washed with water and methanol and dried. The dried product weighed 0.40 g.

Then the filtrate was subjected to centrifugation, but nothing was separated out. It was therefore presumed that about 0.10 g of poly(3,4-ethylenedioxythiophene) was dissolved in 10 mL of hexafluoroisopropanol.

In the Description, the “saturated concentration in fluorinated alcohol (hexafluoroisopropanol in the present example)” is defined from the mass of dispersed or dissolved conductive polymer not remaining on the filter even by filtration. In Referential Example 5, the “saturated concentration in fluorinated alcohol (hexafluoroisopropanol in the present example)” is 0.10 g/10 mL.

In order to confirm that the presumption of dissolution was true, 0.05 g, 0.1 g, 0.15 g, and 0.2 g of poly(3,4-ethylenedioxythiophene) were dissolved separately in 10 mL of hexafluoroisopropanol, and the ultraviolet-visible absorption spectrum of each solution was measured. While the absorption intensity was substantially proportional to the concentration of the solute poly(3,4-ethylenedioxythiophene) until 0.1 g of poly(3,4-ethylenedioxythiophene) was dissolved, the absorption intensities for 0.15 g of poly(3,4-ethylenedioxythiophene) was not proportional to the concentration of the solute. The solubility of poly(3,4-ethylenedioxythiophene) in hexafluoroisopropanol was thus determined to be about 10 g/L (1000 mL).

### Referential Example 6

An experiment was conducted using a mixed solvent of hexafluoroisopropanol and chloroform (mass ratio=4:1) in the same manner as in Referential Example 5. The saturated concentration of poly(3,4-ethylenedioxythiophene) in the mixed solvent of hexafluoroisopropanol and chloroform (mass ratio=4:1) was 0.12 g/10 mL.

### Referential Example 7

An experiment was conducted using 2,2,3,3-tetrafluoro-1-propanol in the same manner as in Referential Example 5. The saturated concentration of poly(3,4-ethylenedioxythiophene) in 2,2,3,3-tetrafluoro-1-propanol was 0.06 g/10 mL.

### Referential Example 8

An experiment was conducted using 2,2,3,4,4,4-hexafluoro-1-butanol in the same manner as in Referential Example 5. The saturated concentration of poly(3,4-ethylenedioxythiophene) in 2,2,3,4,4,4-hexafluoro-1-butanol was 0.04 g/10 mL.

### Referential Example 9

An experiment was conducted for dissolution of polyaniline (polyaniline produced by Aldrich, product number: 47670-6, molecular weight: 10000), using 10 mL of the same solvent (mixed solvent of hexafluoroisopropanol and chloroform (mass ratio=4:1) as used in Referential Example 2. As a result, the saturated concentration of polyaniline in the mixed solvent of hexafluoroisopropanol and chloroform (mass ratio 4:1) was 0.10 g/10 mL.

### Referential Example 10

A filter was immersed in the polypyrrole-dissolving hexafluoroisopropanol prepared in Referential Example 1 and then dried. As a result, a conductive paper constituted of the filter and polypyrrole was produced.

### Referential Example 11

A cotton cloth was immersed in the polypyrrole-dissolving hexafluoroisopropanol prepared in Referential Example 1 and then dried. As a result, a conductive composite constituting of the cloth and polypyrrole was produced.

### Referential Example 12

In 10 mL of the polypyrrole-dissolving hexafluoroisopropanol prepared in Experiment 1, 0.5 g of polyester was dissolved to produce a composite film as a cast including the conductive polymer and the plastic. The resulting film had an electric conductivity of 10³ Ω·cm.

On the other hand, a film produced by dispersing an equal amount (0.15 g) of polypyrrole powder in polyester had an electric conductivity of 10⁸ Ω·cm or more. Thus it was shown that the composite film produced by the method of the invention can exhibit high electric conductivity.

### Referential Example 13)

### Dissolving Polypyrrole in Acetonitrile

In a well-dried 100 cm³ two-neck flask equipped with a stirring paddle and a Liebig reflux condenser, a specified amount 0.03 g of polypyrrole was added to 6 mL of acetonitrile and stirred at 150° C. However, polypyrrole was not dissolved in acetonitrile.

### Referential Example 14

### Dissolving Poly(1,4-Dioxythiophene) in Acetonitrile

In a well-dried 100 cm³ two-neck flask equipped with a stirring paddle and a Liebig reflux condenser, a specific amount 0.03 g of polythiophene was added to 6 mL of acetonitrile and stirred at 150° C. However, polythiophene was not dissolved in acetonitrile.

1. A conductive composition containing a conductive polymer and an ionic liquid, at least part of the conductive polymer being dispersed and/or dissolved in the ionic liquid.

2. The conductive composition according to claim 1, wherein at least part of the conductive polymer is dissolved in the ionic liquid.

3. The conductive composition according to claim 1, wherein the concentration of the conductive polymer in the ionic liquid is at least 0.6 times as high as the saturated concentration of the conductive polymer in the ionic liquid.

4. The conductive composition according to claim 1, wherein the conductive polymer contains at least one selected from the group consisting of polypyrrole and its derivatives, polythiophene and its derivatives, poly(para-phenylene vinylen) and its derivatives, polyaniline and its derivatives, and polyquinone and its derivatives.

5. The conductive composition according to claim 1, wherein the ionic liquid contains at least one cationic component selected from the group consisting of ammonium and its derivatives, imidazolinium and its derivatives, pyridinium and its derivatives, pyrrolidinium and its derivatives, pyrrolinium and its derivatives, pyrazinium and its derivatives, pyrimidinium and its derivatives, triazonium and its derivatives, triazinium and its derivatives, triazine derivative cations, quinolinium and its derivatives, isoquinolinium and its derivatives, indolinium and its derivatives, quinoxalinium and its derivatives, piperazinium and its derivatives, oxazolinium and its derivatives, thiazolinium and its derivatives, morpholinium and its derivatives, and piperazine and its derivatives.

6. The conductive composition according to claim 1, wherein the ionic liquid contains at least one anionic component selected from the group consisting of sulfonate anion (—SO₃⁻), sulfate anion —OSO₃—, carboxylate anion (—COO⁻), BF₄⁻, PF₆⁻, bis(trifluoromethylsulfonyl)imide anion ((CF₃SO₂)₂N⁻), tris(trifluoromethylsulfonyl) carboanion ((CF₃SO₂)₃C⁻), NO₃⁻, and nitro anion (—NO₂⁻).

7. The conductive composition according to claim 1, wherein the conductive composition is prepared through the step of dispersing and/or dissolving the conductive polymer in the ionic liquid.

8. A conductive composition comprising the conductive composition as set forth in claim 1 from which at least part of the ionic liquid is removed.

9. A conductive composition comprising the conductive composition as set forth in claim 1 from which at least part of the ionic liquid is removed by bringing the conductive composition as set forth in claim 1 into contact with a liquid compatible with the ionic liquid.

10. A conductive molded body containing the conductive composition as set forth in claim 1.

11. A conductive molded body produced using the conductive composition as set forth in claim 1.

12. A conductive gel composition comprising the conductive composition as set forth in claim 1 and a gelling agent.

13. The conductive gel composition according to claim 12, wherein the concentration of the conductive polymer in the ionic liquid is at least 0.2 times as high as the saturated concentration of the conductive polymer in the ionic liquid.

14. The conductive gel composition according to claim 12, wherein the concentration of the gelling agent in the ionic liquid is in the range of 0.03 to 0.5 g/mL.

15. The conductive gel composition according to claim 12, wherein the gelling agent contains at least two polar groups or at least two reactive functional groups.

16. A method for producing the conductive gel composition as set forth in claim 12, comprising:
the dissolving step of dissolving at least part of the conductive polymer in the ionic liquid; and the gelating step of gelating the ionic liquid in which at least part of the conductive polymer is dissolved with the gelling agent.

17. The method for producing the conductive gel composition according to claim 16, wherein the gelating step includes the substep of dissolving or dispersing the gelling agent in the ionic liquid in which at least part of the conductive polymer is dissolved.

18. The method for producing the conductive gel composition according to claim 16, wherein the gelating step includes the substeps of: preparing the gelling agent including a first gelling agent having at least two first reactive functional groups and a second gelling agent having at least two second reactive functional groups; dissolving or dispersing the first gelling agent and the second gelling agent in the ionic liquid in which at least part of the conductive polymer is dissolved; and polymerizing the first gelling agent and the second gelling agent.
